(19) United States
(12) Patent Application Publication
(10) Pub. No.: US 2011/0320741 A1
(43) Pub. Date: Dec. 29, 2011

(54) METHOD AND APPARATUS PROVIDING FOR DIRECT CONTROLLED ACCESS TO A DYNAMIC USER PROFILE

(75) Inventors: Jilei Tian, Tampere (FI); Sailesh Sathish, Tampere (FI); Rile Hu, Beijing (CN); Wenfeng Li, Beijing (CN)

(73) Assignee: Nokia Corporation

(21) Appl. No.: 12/824,677

(22) Filed: Jun. 28, 2010

(51) Int. Cl. G06F 12/00

(52) U.S. Cl. 711/147; 711/E12.001

(57) ABSTRACT

An apparatus may include a profile determiner configured to determine a user profile. A contextual characteristic determiner may be configured to determine contextual characteristics relating to the apparatus and/or the user of the apparatus such that the profile determiner may infer user preferences and thereby create a dynamic portion of the user profile. An index builder may be configured to build an index of profile categories included within the user profile. A subscription registrar may cause the user profile to be registered for sharing with a service provider. Thereby a profile manager may provide for direct controlled access to the user profile which may be limited by user selection of permission levels and/or profile categories which are shared. Thereby access to the user profile may occur directly with the apparatus without storing the user profile on a separate server.

### TECHNOLOGICAL FIELD

Embodiments of the present invention relate generally to providing access to a user profile and, more particularly, relate to an apparatus, method and a computer program product configured to cause a dynamic user profile to be registered for sharing, and provide for direct controlled access to the dynamic user profile.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

With the proliferation of mobile terminals, additional functionally has also emerged. In this regard, some mobile terminals may now receive customized content through services. The customization of the content may be based on a user profile for the user and/or contextual information sensed by the mobile terminal such as the present location of the user. Thus, for example, the user may be provided with sports score information relating to the user's present location and/or the user's interests. Thereby, for example, the user may be provided with targeted recommendations for content and targeted services. However, in order for services to provide customized content, the services may require access to the user profile which may present logistical difficulties and privacy concerns.

### BRIEF SUMMARY

A method, apparatus and computer program product are therefore provided that provide for direct controlled access to a dynamic user profile.

In an example embodiment, an improved apparatus comprises at least one processor and at least one memory including computer program code, the at least one memory and the computer program code configured to, with the processor, cause the apparatus to cause a dynamic user profile to be registered for sharing, and provide for direct controlled access to the dynamic user profile.

In an additional example embodiment a method comprises registering a dynamic user profile for sharing, and providing for direct controlled access to the dynamic user profile via a processor.

In a further example embodiment a computer program product comprises at least one computer-readable storage medium having computer-executable program code portions stored therein, the computer-executable program code portions comprising program code instructions for registering a dynamic user profile for sharing, and program code instructions providing for direct controlled access to the dynamic user profile.

In some embodiments the apparatus may be further configured to determine the dynamic user profile from a user action and from a contextual characteristic associated with the user action. The apparatus may also be configured to build an index of one or more profile categories comprising the dynamic user profile and provide for selection of the one or more profile categories for sharing. The apparatus may additionally be configured to provide for output of a notification in an instance in which a piece of data in one of the profile categories which is shared changes. Further, the apparatus may be configured to provide for selection of a permission level for controlling access to the dynamic user profile and in some embodiments configured to separately provide for selection of the permission level for each of a plurality of services. Similar embodiments of the method and computer program product are also provided. Accordingly, embodiments of the present invention may provide for direct controlled access to a dynamic user profile and some embodiments of the invention may thereby avoid storing the dynamic user profile on a separate server.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to cause a dynamic user profile to be registered for sharing and provide for direct controlled access to the dynamic user profile according to an example embodiment of the present invention

FIG. 3 illustrates a schematic block diagram of an example of an alternate system for sharing user profile information; and

FIG. 4 illustrates a flowchart of the operations performed in registering a dynamic user profile for sharing and providing for direct controlled access to the dynamic user profile according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

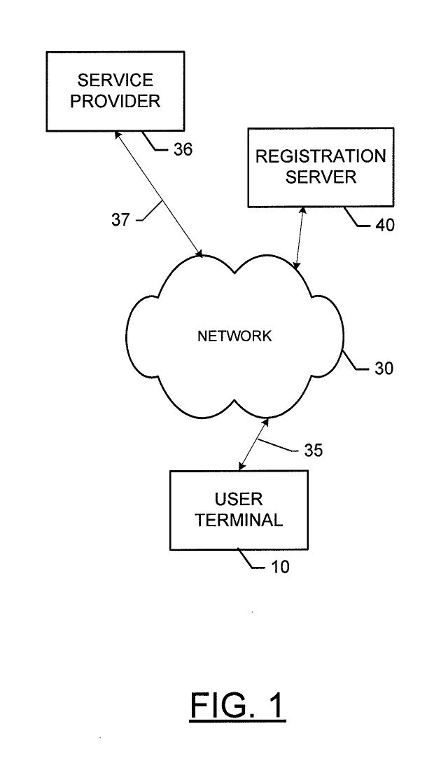

As indicated above, some embodiments of the present invention may be employed in methods, apparatuses and computer program products configured to cause a dynamic user profile to be registered for sharing and provide for direct controlled access to the dynamic user profile. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the mobile terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The system may further comprise a service provider 36. In some embodiments the service provider 36 may be embodied as a server, server bank or other computer or other computing device or node configured to provide services and content to the user terminal 10. In some embodiments the service provider 36 may provide services and/or content based on a user profile corresponding to the user terminal 10 when providing services and content thereto. The service provider 36 may have any number of functions or associations with various services. As such, for example, the service provider 36 may be a platform such as a dedicated server (or server bank), or the service provider may be a backend server associated with one or more other functions or services. Thus, the service provider 36 may potentially provide a variety of different services and/or content to the user terminal 10. In some embodiments the service provider 36 may provide commercial and/or non-commercial content and services. Accordingly, the operations performed by the service provider 36 may or may not comprise processing payment in exchange for distributing the content and services. In some embodiments payment may be processed by a separate device. Further, although the service provider 36 is herein generally described as a server, in some embodiments the service provider may be embodied in the user terminal 10, such an application operating therein, or embodied on the network 30. Applications, as used herein, refer to software, programs, and other stored instructions which are configured to provide services and/or content.

The system may additionally comprise a registration server 40. In some embodiments the registration server 40 may be embodied as a server, server bank or other computer or other computing device or node configured to register a user profile for sharing. The registration server 40 may have any number of functions or associations with various services. As such, for example, the registration server 40 may be a platform such as a dedicated server (or server bank), or the registration server may be a backend server associated with one or more other functions or services. Thus, the registration server 40 may register user profiles, for example a user profile associated with the user terminal 10, with a variety of service and content providers, such as the service provider 40. In this regard, the registration server 40 may indicate to the service provider 36 the user's willingness to receive services as indicated to the registration server by the user terminal 10. Thereafter, the user terminal 10 may negotiate directly with the service provider 36 to determine the user profile information which is shared with the service provider 36 as will be described below. Further, although the registration server 40 is herein generally described as a server, in some embodiments the registration server may be embodied as a portion of the user terminal 10, such an internal module therein, or embodied on the network 30.

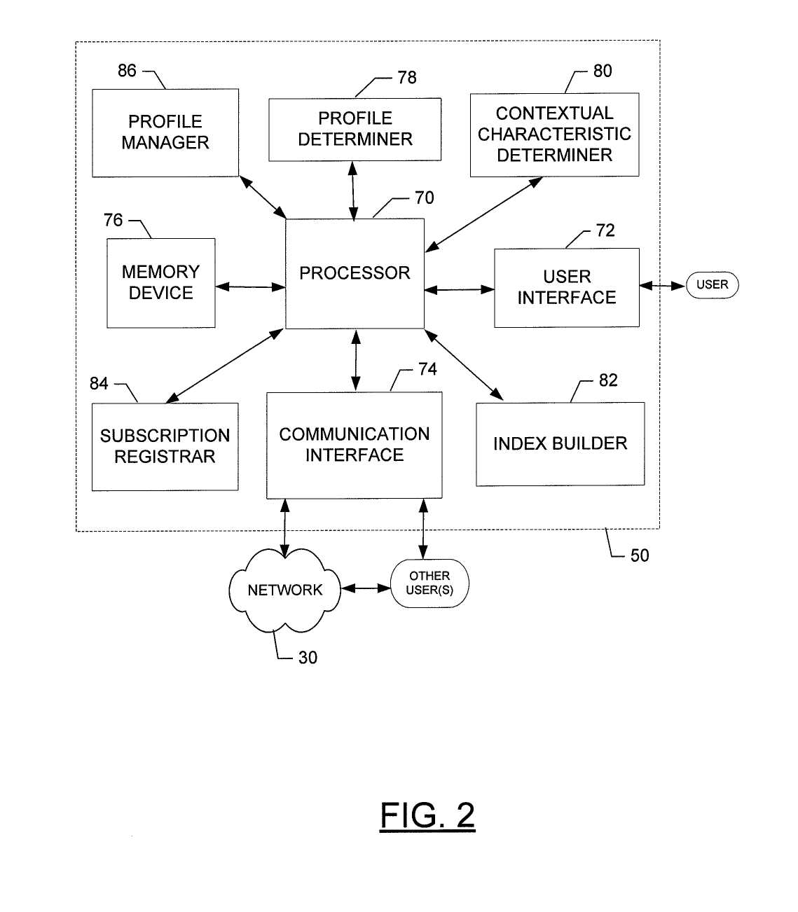

In an example embodiment, an apparatus 50 is provided that may be employed by devices performing example embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30 and/or the registration server 40. As such, the apparatus 50 of FIG. 2 is merely an example and may include more, or in some cases less, than the components shown in FIG. 2.

With further regard to FIG. 2, the apparatus 50 may be configured to cause a user profile to be registered for sharing and provide for direct controlled access to the user profile. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may further include a profile determiner 78. The processor 70 may be embodied as, include or otherwise control the profile determiner 78. The profile determiner 78 may be configured to determine a user profile. In this regard, the user profile may in some embodiments comprise a static portion and a dynamic portion. When the user profile comprises a dynamic portion, the user profile may be referred to as a dynamic user profile. The static portion of the user profile may comprise information such as the nationality, preferred language, age, sex, etcetera of the user. Thus, the static portion of the user profile includes information which may stay the same for extended periods of time or which may be easily updated. For example, age may be easily updated if the user's birthday is known. Therefore, the profile determiner 78 may determine the static portion of the user profile by requesting and receiving user entry of basic user information.

Whereas the static portion of the user profile may include information which is unlikely to change frequently, the dynamic portion of the user profile may relate to information which is more likely to change on a relatively frequent basis. In this regard, it may be inconvenient for a user to continually update the dynamic portion of the user profile with information relating to, for example, musical preferences and current location of the user. Therefore, the profile determiner 78 may in some embodiments attempt to infer some user preferences in order to create the dynamic portion of the user profile.

In order to determine the dynamic portion of the user profile, the apparatus 50 may further comprise a contextual characteristic determiner 80. The processor 70 may be embodied as, include or otherwise control the contextual characteristic determiner 80. The contextual characteristic determiner 80 may be configured to determine one or more contextual characteristics. Contextual characteristics, as used herein, refer to the context of the user and/or the apparatus 50, and thus contextual characteristics may include the present time, location, activity, etcetera of the user and/or the apparatus. Thus, for example, the contextual characteristic determiner 80 may determine that the user is presently at home, outside walking, or riding a bus. Information relating to the location of the user may, for example, be provided by a GPS module, though location information may additionally or alternatively be provided through other means such as triangulation using cell phone towers in some embodiments. Thus, the apparatus 50 may determine one or more contextual characteristics.

The profile determiner 78 may thereby use the contextual characteristics of the user and/or apparatus 50 as determined by the contextual characteristic determiner 80 to determine the dynamic portion of the user profile. In this regard, the profile determiner 78 may determine the dynamic portion of a dynamic user profile from a user action and from a contextual characteristic associated with the user action. For example, a user action may comprise listening to jazz music using the apparatus 50. The profile determiner 78 may combine the user action with the contextual characteristics associated with this user action to determine the dynamic portion of the user profile. For example, the user may tend to listen to jazz music between the hours of 7 PM and 8 PM while riding the bus home. Therefore, the profile determiner 78 may infer that the user likes to listen to jazz between the hours of 7 PM and 8 PM and/or while riding the bus, and thus this information may be added by the profile determiner to the dynamic portion of the user profile. Note that in some instances a user action may include something the user did not do. By way of example, a user may tend to not answer calls when the user is driving. In this regard, the user action may comprise not answering calls, and the contextual characteristic may comprise driving the car. Accordingly, the profile determiner 78 may build the dynamic portion of the user portion with inferred user preferences. Therefore, the user may not have to manually enter all of his or her user preferences, which may in some instances be complicated and/or frequently changing.

The apparatus 50 may further comprise an index builder 82. The processor 70 may be embodied as, include or otherwise control the index builder 82. The index builder 82 may be configured to build an index of one or more profile categories comprising the user profile. In this regard, the profile categories may comprise predetermined profile categories in some instances. For example the index builder may build the index using ontology classification techniques. Thereby, for example, the index may be arranged into profile categories based on contextual characteristics, and/or user activities in some embodiments.

The apparatus 50 may also comprise a subscription registrar 84. The processor 70 may be embodied as, include or otherwise control the subscription registrar 84. The subscription registrar 84 may be configured to cause a user profile to be registered for sharing. In this regard, for example, the subscription registrar 84 may be configured to provide the registration server 40 with a plurality of information relating to the user profile and the user terminal 10 when the apparatus 50 is embodied in the user terminal. For example, the apparatus 50 may provide an identifier for the device such as a Session Initiation Protocol (SIP) address, phone number, or account name; a subscription address such as a SIP address or Internet Protocol (IP) address; the type of ontology used to classify the contextual characteristics or a list of the contextual characteristics supported; country information relating to the country in which the user resides; the service provider name; current profile categories as determined by the profile determiner 78; and privacy levels supported. The subscription registrar 84 may also provide information to the registration server 40 relating to the type of services which the user of the apparatus 50 is willing to receive. When the apparatus 50 is embodied in the user terminal 10 causing the user profile to be registered for sharing may involve transmitting this information to the registration server 40. Further, when there are major changes to the user profile, for example changes in the profile categories which appear in the user profile, the subscription registrar 84 may update the registration server 40 by retransmitting the above-described information.

With the apparatus 50 registered as described above, the service provider 36, for example, may contact the registration server 40 in order to gain access to information needed to contact the apparatus 50 and thereby receive the user profile from the apparatus and provide content and/or services thereto. The service provider 36 may in some embodiments contact the registration server 40 using known methods for searching registries. In order for the service provider 36 (or other service providers) to subscribe to the user profile, the apparatus 50 may further comprise a profile manager 86. The processor 70 may be embodied as, include or otherwise control the profile manager 86. The profile manager 86 may be configured to control access to the user profile. In this regard, the service provider 36 may send a subscription request to the apparatus 50 once the service provider has received the necessary contact information from the registration server 40. The subscription request may include information such as the name of the service; a textual description of the service; user profile categories from which information is requested; permission levels needed for each user profile category; a description of the way in which the data from the profile categories would be used; any authentication certificates; requested update frequency for user profile information; and cost of subscribing to the service.

Accordingly, the profile manager 86 may provide the user with the opportunity to deny, accept, or partially accept the subscription request, which may be received directly from the service provider 36. Thus, the registration server 40 may not be involved in communications between the service provider 36 and the apparatus 50 after the registration server determines that the apparatus would be interested in receiving the service (as determined based on user willingness information supplied by the apparatus) and provides the service provider with apparatus contact information. Notably, the user of the apparatus 50 may be provided with the choice of what information and what level of information is provided to each service provider. In this regard, the profile manager 86 may provide for selection of one or more of the profile categories for sharing. Thus, the user may select which profile categories are shared with the service provider 36. The profile manager 86 may also be configured to provide for selection of a permission level for controlling access to the user profile. In some embodiments the profile manager 86 may suggest the permission level. Further, in some embodiments the profile manager 86 may provide for selection of a permission level for each of the profile categories. Also, the profile manager 86 may separately provide for selection of the permission level for each of a plurality of service providers. Thereby, in some embodiments the user may be able to select different permission levels for different service providers. Thus, the user may for example allow a more trusted service provider, such as one with an authentication certificate, greater access to the user profile information.

In some embodiments the permission level may be settable between a plurality of discrete settings. For example, the permission levels may be settable between three settings which grant varying levels of access to the user profile. In this regard, the profile manager 86 may embody logic intended to categorize the user profile information into varying levels of abstraction. By way of example with regard to the above-described determined user preference of listening to jazz on the bus between 7 PM and 8 PM, when the permission level is high, the profile manager 86 may provide for access to all of this information. When the permission level is set to medium, the profile manager 86 may for example provide for access to the information that the user likes to listen to jazz on the bus. When the permission level is set to low, the profile manager 86 may for example only provide access to the information that the user likes music. Accordingly, the profile manager 86 may provide for controlled access to the user profile.

After the profile manager 86 allows the user to accept, partially accept, or deny the subscription request from the service provider 36, the service provider may have an opportunity to respond to the selection of the shared profile categories and the corresponding permission levels. In this regard, the service provider 36 may indicate to the user that the selected profile categories and permission levels are insufficient to provide services and/or content. Alternatively, the service provider 36 may indicate that providing the service and/or content is still possible, but the service provider may indicate any functionality which is hampered by the unselected profile categories or selected permission levels. Accordingly, the user may know what functionality to expect from the service provider 36.

Thereby, the service provider 36 may begin providing service to the apparatus 50 using the access to the user profile as provided by the above-described subscription process. In some embodiments the acceptance of the subscription may result in the installation of an application on the apparatus 50, whereas in other embodiments the service 36 may not install an application on the apparatus. Regardless, the service provider 36 is provided with direct controlled access to the user profile. Access is controlled by the subscription request process described above. Further, the access is direct in the sense that the user profile may be stored in the apparatus 50, for example in the memory device 76, and the service provider 36 accesses the user profile directly from the apparatus, as opposed to accessing the user profile from an external server or other external storage device. For example, as illustrated in FIG. 1, direct access to the user profile may include a first communication 35 between the user terminal 10 and the network 30 and a second communication 37 between the network and the service provider 36. Thereby, access to user profile information may occur directly through communication between the user terminal 10 (which may comprise the apparatus 50) and the service provider 36 without involving the registration server 40 after the service provider receives the user terminal contact information from the registration server. In this regard, the user and the apparatus 50 may retain greater control over the information in the user profile, because the information may be stored internally instead of on an external device such as a server.

Once the subscription begins, the profile manager 86 may provide for output of a notification to the service provider 36 in an instance in which a piece of data in one of the profile categories which is shared changes. In some embodiments the notification may indicate which profile categories have become active. In this regard, for example, the profile category relating to music, and in particular jazz music, would become active between the hours of 7 PM and 8 PM under the above described example. Thereby after being notified by the profile manager 86, the service provider 36 may provide services and/or content to the user which relate to jazz music.

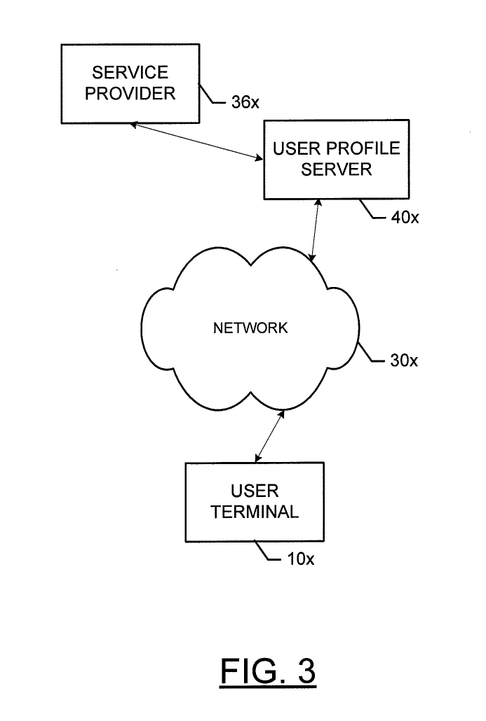

Further, as described above, the user may select one or more of the profile categories for sharing, and further the user may be able to select different permission levels for different service providers as described above. Thus, the user may be able to select the type and amount of information which is shared. Additionally, this may be conducted for each service provider. Thereby, the user may retain profile information within the apparatus 50, and only share the type and level of information which is desired such that different service providers may be provided with different amounts of information. In this regard, other systems may not provide the same level of security and customization for different service providers. For example, FIG. 3 illustrates a schematic block diagram of an example of an alternate embodiment of a system for sharing a user profile which does not include all of the features elsewhere described herein. As illustrated the system may include a user terminal 10x, a network 30x, a service provider 36x, and a user profile server 40x. In this system, the user terminal 10x, may upload a user profile to the user profile server 40x through the network 30x. Thereby, the service provider 36x may contact the user profile server 40x to receive user profile information.

However, this system may not allow the user to maintain complete control of the user profile information. In this regard, the user profile information is maintained on the user profile server 40x, which may not be completely secure and/or the user profile server may not be completely trustworthy. Further, the user may not be provided the opportunity to control which service providers have access to the user profile information in the user profile server 40x, and the user may not be able to set permission levels for each respective service provider. In this regard, the user may decide to only provide very minimal information to the user profile server 40x, and accordingly, some service providers, for example service provider 36x may not be provided with all of the user profile information necessary to provide full service capabilities. Accordingly, the apparatus and system described herein may provide benefits over alternate systems such as the system illustrated in FIG. 3.

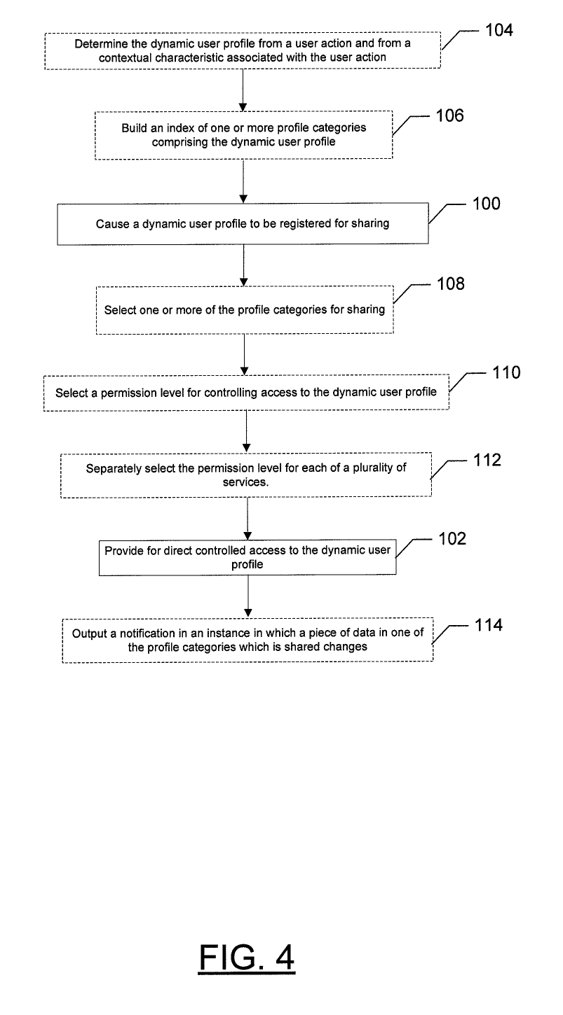

In terms of methods associated with embodiments of the present invention, the above-described apparatus 50 or other embodiments of apparatuses may be employed. In this regard, FIG. 4 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method includes registering a dynamic user profile for sharing at operation 100. Further, the method may include providing for direct controlled access to the dynamic user profile at operation 102.

In some embodiments, certain ones of the above-described operations (as illustrated in solid lines in FIG.) may be modified or further amplified. In some embodiments additional operations may also be included (some examples of which are shown in dashed lines in FIG. 4). It should be appreciated that each of the modifications, optional additions or amplifications may be included with the above-described operations (100-102) either alone or in combination with any others among the features described herein. As such, each of the other operations as will be described herein may be combinable with the above-described operations (100-102) either alone or with one, more than one, or all of the additional operations in any combination.

For example, the method may further comprise determining the dynamic user profile from a user action and from a contextual characteristic associated with the user action at operation 104. The method may additionally include building an index of one or more profile categories comprising the dynamic user profile at operation 106. Further, the method may include providing for selection of one or more of the profile categories for sharing at operation 108. Also, the method may comprise providing for selection of a permission level for controlling access to the dynamic user profile at operation 110. In some embodiments the method may further comprise separately providing for selection of the permission level for each of a plurality of services at operation 112. The method may additionally comprise providing for output of a notification in an instance in which a piece of data in one of the profile categories which is shared changes at operation 114.

In an example embodiment, an apparatus for performing the method of FIG. 4 and other methods described above may comprise a processor (for example, the processor 70) configured to perform some or each of the operations (100-114) described above. The processor may, for example, be configured to perform the operations (100-114) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-114 may comprise, for example, the processor 70, the user interface 72, the communication interface 74, the profile determiner 78, the contextual characteristic determiner 80, the index builder 82, the subscription registrar 84, and/or the profile manager 86, as described above. However, the above-described portions of the apparatus 50 as they relate to the operations of the method illustrated in FIG. 4 are merely examples, and it should be understood that various other embodiments may be possible.

In some embodiments the operation 100 of registering a dynamic user profile for sharing may be conducted by means, such as the subscription registrar 84, the communication interface 74, and/or the processor 70. Further, the operation 102 of providing for direct controlled access to the dynamic user profile may be conducted by means, such as the profile manager 86, the communication interface 74, and/or the processor 70. Additionally, the operation 104 of determining the dynamic user profile from a user action and from a contextual characteristic associated with the user action may be conducted by means, such as the contextual characteristic determiner 80, the profile determiner 78, and/or the processor 70. Also, the operation 106 of building an index of one or more profile categories comprising the dynamic user profile may be conducted by means, such as the index builder 82, and/or the processor 70. Further, the operation 108 of providing for selection of one or more of the profile categories for sharing, the operation 110 of providing for selection of a permission level for controlling access to the dynamic user profile, the operation 112 of separately providing for selection of the permission level for each of a plurality of services, and the operation 114 of providing for output of a notification in an instance in which a piece of data in one of the profile categories which is shared changes may be conducted by means, such as the profile manager 86, the communication interface 74, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
cause a dynamic user profile to be registered for sharing; and
provide for direct controlled access to the dynamic user profile.

2. The apparatus of claim 1, further configured to determine the dynamic user profile from a user action and from a contextual characteristic associated with the user action.

3. The apparatus of claim 1, further configured to build an index of one or more profile categories comprising the dynamic user profile and provide for selection of one or more of the profile categories for sharing.

4. The apparatus of claim 3, further configured to provide for output of a notification in an instance in which a piece of data in one of the profile categories which is shared changes.

5. The apparatus of claim 1, further configured to provide for selection of a permission level for controlling access to the dynamic user profile.

6. The apparatus of claim 5, further configured to separately provide for selection of the permission level for each of a plurality of services.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
causing a dynamic user profile to be registered for sharing; and
providing for direct controlled access to the dynamic user profile via a processor.

9. The method of claim 8, further comprising determining the dynamic user profile from a user action and from a contextual characteristic associated with the user action.

10. The method of claim 8, further comprising building an index of one or more profile categories comprising the dynamic user profile.

11. The method of claim 10, further comprising providing for selection of one or more of the profile categories for sharing.

12. The method of claim 10, further comprising providing for output of a notification in an instance in which a piece of data in one of the profile categories which is shared changes.

13. The method of claim 8, further comprising providing for selection of a permission level for controlling access to the dynamic user profile.

14. The method of claim 13, further comprising separately providing for selection of the permission level for each of a plurality of services.

15. A computer program product comprising at least one computer-readable storage medium having computer-executable program code portions stored therein, the computer-executable program code portions comprising:
program code instructions causing a dynamic user profile to be registered for sharing; and
program code instructions providing for direct controlled access to the dynamic user profile.

16. The computer program product of claim 15, further comprising program code instructions for determining the dynamic user profile from a user action and from a contextual characteristic associated with the user action.

17. The computer program product of claim 16, further comprising program code instructions for building an index of one or more profile categories comprising the dynamic user profile; and
program code instructions providing for selection of one or more of the profile categories for sharing.

18. The computer program product of claim 15, further comprising program code instructions providing for output of a notification in an instance in which a piece of data in one of the profile categories which is shared changes.

19. The computer program product of claim 15, further comprising program code instructions providing for selection of a permission level for controlling access to the dynamic user profile.

20. The computer program product of claim 19, further comprising program code instructions for separately providing for selection of the permission level for each of a plurality of services.
